(19) United States
(12) Patent Application Publication
(10) Pub. No.: US 2014/0232608 A1
(43) Pub. Date: Aug. 21, 2014

(54) Antenna Apparatus and a Method

(71) Applicant: Anping Zhao, Beijing (CN)

(72) Inventor: Anping Zhao, Beijing (CN)

(73) Assignee: Nokia Corporation, Espoo (FI)

(21) Appl. No.: 14/347,309

(22) PCT Filed: Sep. 26, 2011
(86) PCT No.: PCT/CN2011/080163

§ 371 Date: Mar. 26, 2014

(51) Int. Cl. H01Q 7/00

(52) U.S. Cl. CPC H01Q 7/00
USPC 343/866; 29/600

(57) ABSTRACT

An apparatus including: a central portion extending at least in a first direction on an upper surface of a dielectric substrate; a first lateral portion and a second lateral portion extending at least in a second direction, orthogonal to the first direction, on one or more side surfaces of the dielectric substrate to the upper surface of the dielectric substrate wherein the central portion provides a first conductive path between the first lateral portion and the second lateral portion; a second conductive path between the first lateral portion and the second lateral portion; and a monopole antenna element extending in the second direction.

### TECHNOLOGICAL FIELD

Embodiments of the present invention relate to an antenna apparatus and a method. In particular, they relate to an ultra wideband antenna apparatus.

### BACKGROUND

An antenna apparatus is used for the transmission and/or reception of radio frequency electromagnetic radiation.

An ultra wideband antenna apparatus is used for the transmission and/or reception across a large bandwidth of radio frequency electromagnetic radiation. The large bandwidth may be greater that 500 MHz.

The design and manufacture of ultra wideband antenna apparatus can be difficult as the antenna apparatus needs to have a low insertion loss over the large bandwidth.

### BRIEF SUMMARY

According to various, but not necessarily all, embodiments of the invention there is provided an apparatus comprising: a central portion extending at least in a first direction on an upper surface of a dielectric substrate; a first lateral portion and a second lateral portion extending at least in a second direction, orthogonal to the first direction, on one or more side surfaces of the dielectric substrate to the upper surface of the dielectric substrate; wherein the central portion provides a first conductive path between the first lateral portion and the second lateral portion; a second conductive path between the first lateral portion and the second lateral portion; and a monopole antenna element extending in the second direction.

According to various, but not necessarily all, embodiments of the invention there is provided a method comprising:

providing a central portion extending at least in a first direction on an upper surface of a dielectric substrate; a first lateral portion and a second lateral portion extending at least in a second direction, orthogonal to the first direction, on one or more side surfaces of the dielectric substrate to the upper surface of the dielectric substrate; wherein the central portion provides a first conductive path between the first lateral portion and the second lateral portion; and a second conductive path between the first lateral portion and the second lateral portion; and
providing a monopole antenna element extending in the second direction.

According to various, but not necessarily all, embodiments of the invention there is provided an apparatus comprising:

a dielectric substrate having an upper surface, side surfaces and a base surface;
one or more antenna elements supported by the dielectric substrate;
a part on the base surface of the dielectric substrate for surface mounting the apparatus and for forming an electrical connection to at least one of the one or more antenna elements.

### BRIEF DESCRIPTION

For a better understanding of various examples of embodiments of the present invention reference will now be made by way of example only to the accompanying drawings in which:

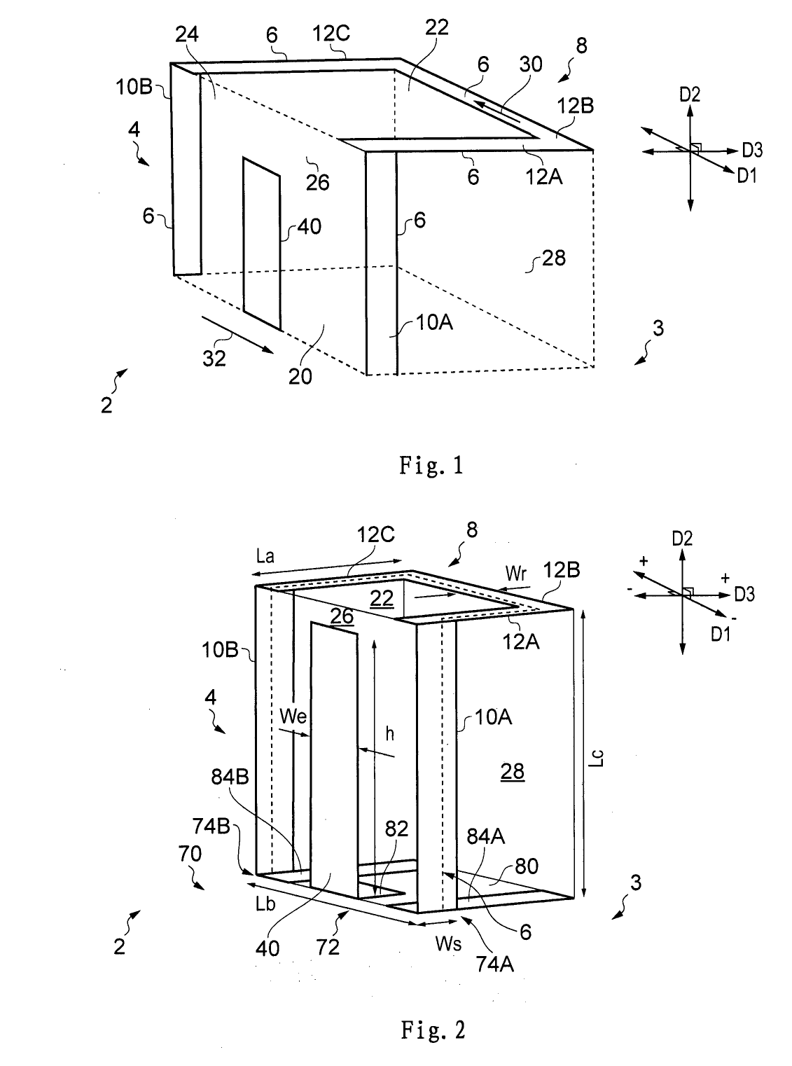

FIG. 1 schematically illustrates an example of an antenna apparatus;

FIG. 2 schematically illustrates an example of an apparatus similar to that illustrated in FIG. 1;

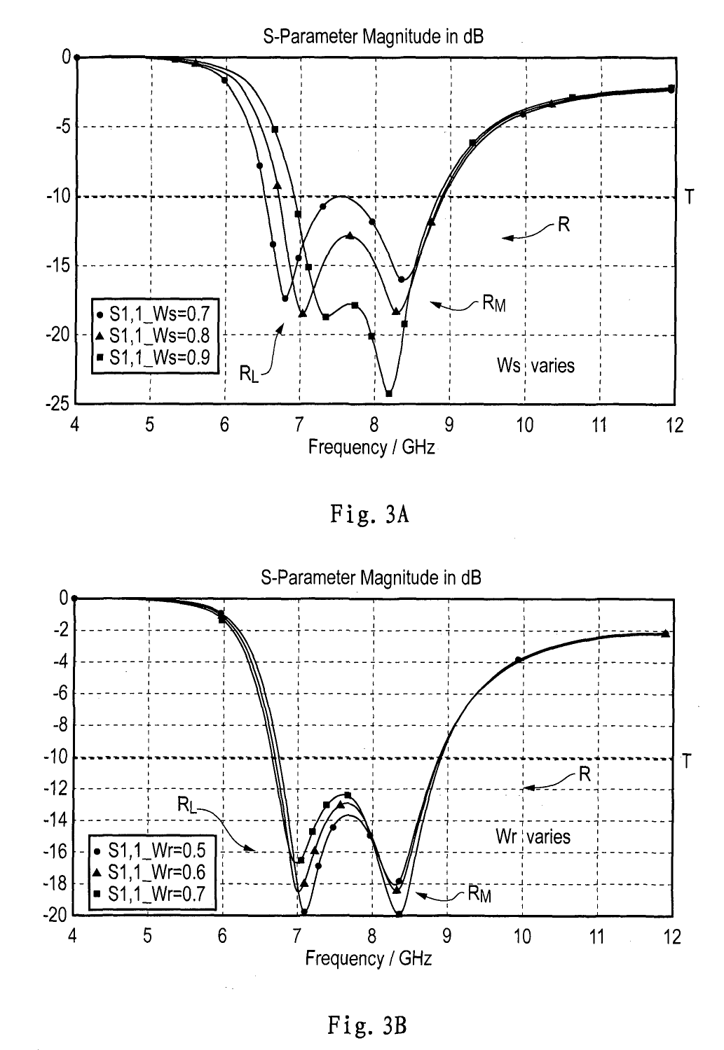

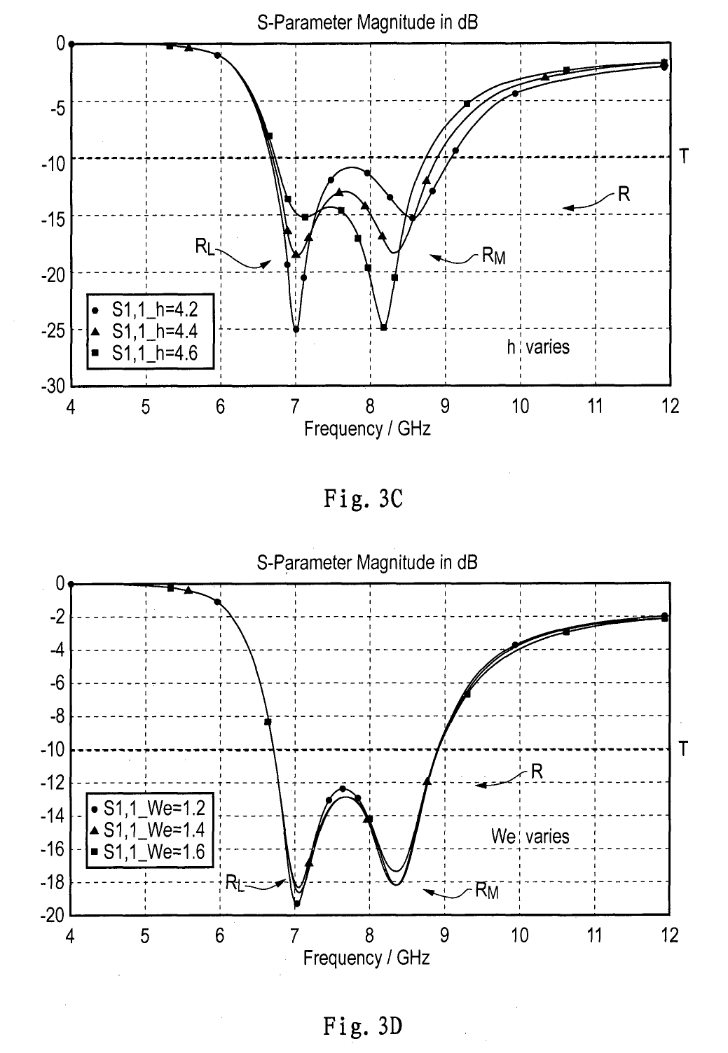

FIGS. 3A, 3B, 3C and 3D illustrate radio frequency characteristics of the apparatus;

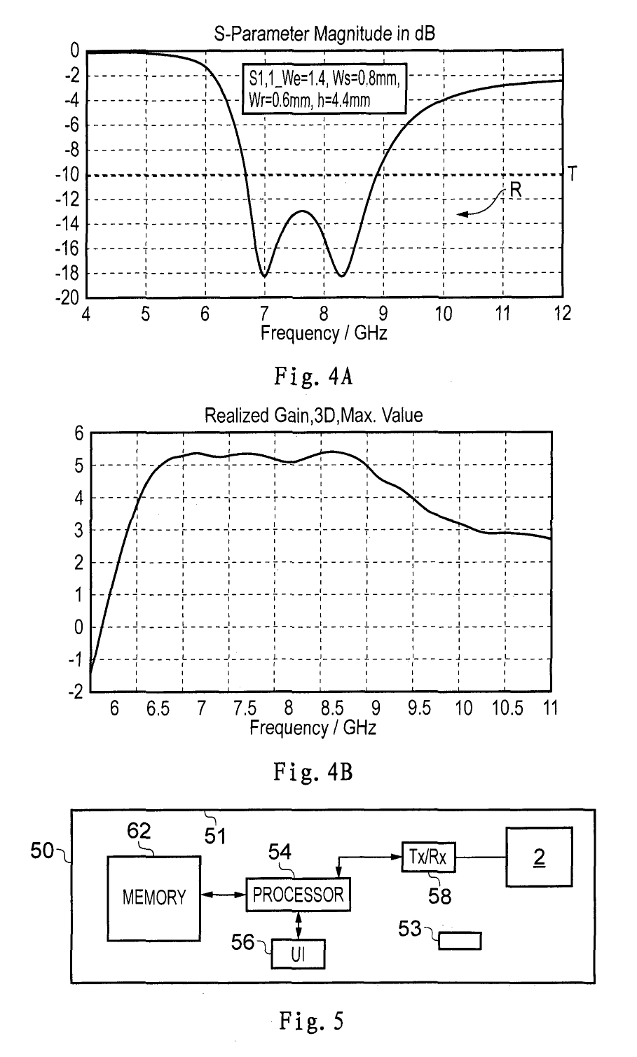

FIG. 4A illustrates a combined resonance R for an apparatus;

FIG. 4B illustrates a plot of the realized gain; and

FIG. 5 schematically illustrates a user apparatus that comprises the apparatus and uses it as an antenna.

### DETAILED DESCRIPTION

The Figures illustrate an antenna apparatus 2 comprising:

a loop antenna 4 comprising:
an antenna element 6 comprising:
   a central portion 8 extending at least in a first direction D1 on an upper surface 22 of a dielectric substrate 20; and
   a first lateral portion 10A and a second lateral portion 10B extending at least in a second direction D2, orthogonal to the first direction D1, on one or more side surfaces 28, 26 of the dielectric substrate 20 to the upper surface 22 of the dielectric substrate 20;
      wherein the central portion 8 provides a first conductive path 30 between the first lateral portion 10A and the second lateral portion 10B; and
a second conductive path 32 between the first lateral portion 10A and the second lateral portion 10B; and
   a monopole antenna element 40 extending in the second direction D2 and configured to indirectly feed the loop antenna 4.

FIG. 1 schematically illustrates an example of an antenna apparatus 2 comprising: a loop antenna 4 and a monopole antenna element 40 configured to provide an indirect feed to/from the loop antenna 4.

The apparatus 2 provides an antenna arrangement that has an acceptable impedance bandwidth and efficiency over a defined large frequency range making it suitable for use as a wide-band antenna.

The defined frequency range is large in that it is greater than 500 MHz or 20% of the center frequency. The defined frequency range may, for example, be between 7.2 and 8.5 GHz making the apparatus 2 suitable for use as an ultra wide band (UWB) antenna.

The loop antenna 4 is a parasitic element having the monopole antenna element 40 as an indirect feed.

The loop antenna comprises: an antenna element 6 comprising a first conductive path 30 via a first lateral portion 10A, a central portion 8 and a second lateral portion 10B and a second conductive path 32 between the first lateral portion 10A and the second lateral portion 10B.

In the illustrated example, the second conductive path 32 is via a ground plane 3.

In the illustrated example, the central portion 8 extends at least in a first direction D1. The first lateral portion 10A is coupled (e.g. connected) to the central portion and extends at least in a second direction D2, orthogonal to the first direction D1. The second lateral portion 10B is also coupled (e.g. connected) to the central portion and extends at least in the second direction D2, orthogonal to the first direction D1.

A dielectric substrate 20 supports on an upper surface 22 the central portion 8. In this example, the upper surface 22 is planar (flat) and the central portion 8 is also planar (flat). In other examples, the upper surface 22 is not planar (flat) and/or the central portion 8 is not planar (flat). The first lateral portion 10A and the second lateral portion 10B are positioned on opposing side surfaces 28, 26 of the dielectric substrate 20. They extend substantially perpendicularly from the ground plane 3 at the bases of the respective opposing side surfaces to the upper surface 22 where they connect with the central portion 8 on the upper surface 22 of the dielectric substrate 20.

The monopole antenna element 40 extends from a feed at a base of the dielectric substrate 20 in the second direction D2. It is configured to indirectly and electromagnetically feed the loop antenna 4. The monopole antenna element 40 is positioned on a front surface 24 of the dielectric substrate 20. The front surface 24 is bounded to its top by the upper surface 22 and to its sides by the opposing side surfaces 26, 28.

The dielectric substrate 20 may be a ceramic such as an electro-ceramic with a high relative permittivity e.g. greater than 4. For example, the dielectric substrate may be ceramic with a relative permittivity of 6.7. In some embodiments the dielectric substrate 20 may be plastic or some other polymer either loaded with ceramic or not loaded with ceramic. The dielectric substrate 20 may be any suitable non-conductive material for radio frequency antennas.

The dielectric substrate may have a melting point in excess of the temperature required during a surface mounted device (SMD) procedure.

A high permittivity of a dielectric substrate material decreases the volume of the antenna apparatus 2.

A dielectric substrate material having a low loss tangent increases the antenna efficiency.

A ceramic dielectric substrate has a melting point in excess of the temperature required during a surface mounted device (SMD) procedure, a high permittivity and a low loss tangent.

Although in this example, the first lateral portion 10A and the second lateral portion 10B are positioned on opposing side surfaces 28, 26 of the dielectric substrate 20 in other embodiments they may alternatively be placed on the same surface as the monopole antenna element 40, the front surface 24, or on a rear surface opposing the front surface.

FIG. 2 schematically illustrates an example of an apparatus 2 similar to that illustrated in FIG. 1 and similar references are used to refer to similar features.

In this example, the dielectric substrate 20 is a rectangular parallelepiped (a cuboid).

The upper surface 22 is a plane bounded by a rectangle that is orthogonal to the opposing side surfaces 26, 28 and the front surface 20. Each of the opposing side surfaces 26, 28 are parallel planes bounded by rectangles of the same size. The front surface 20 is also a plane bounded by a rectangle.

The cuboid dielectric has a depth La in a third direction D3 orthogonal to the first direction D1 and the second direction D2, a width Lb in the first direction D1 and a height Lc in the second direction D2.

In this example, the central portion 8 is ‘open’, that is there is only one electrical path between the first lateral portion 10A and the second lateral portion 10B via the central portion 8. However, in other embodiments, the central portion 8 may be ‘closed’, that is there is more than one electrical path between the first lateral portion 10A and the second lateral portion 10B via the central portion 8 and the one of more electrical paths therefore form one or more closed loops. When the central portion is closed, it may be symmetrical with the paths having reflection symmetry with respect to a virtual line between where the first lateral portion 10A meets the central portion 8 and where the second lateral portion 10B meets the central portion 8. The illustrated example, saves space when compared to an embodiment that uses a closed, symmetrical central portion 8 because it has a smaller depth La.

In the illustrated example, the depth La is significantly less than the width Lb and significantly less than the height Lc. In this example, the width Lb and the height Lc are approximately equal.

For example, the depth La may be 3.2 mm, the width Lb may be 5 mm and the height Lc may be 5 mm.

In the illustrated example, the first lateral element 10A and the second lateral element 10B extend substantially perpendicularly from the ground plane 3 in the second direction D2 to a height Lc and have a width Wₛ in the third direction D3.

In the illustrated example, the central portion comprises a first portion 12A extending in the third direction D3, a second portion 12B extending in the first direction D1; and a third portion 12C extending in the third direction D3, but in an opposite sense to the first portion 12A.

In this example, the central portion 8 forms an open rectangle. The first portion 12A is rectilinear and extends only in the third direction D3, the second portion 12B is rectilinear and extends in only the first direction D1 and the third portion 12C is rectilinear and extends in only the third direction D3. However, other arrangements may be possible.

For example, the central portion 8 may form a curve. The first portion 12A extending in the third direction (positive sense) and the first direction, the second portion 12B extending in the first direction and also the third direction first in a positive sense then in the opposite negative sense and the third portion 12C extending in the third direction (negative sense) and the first direction.

In the illustrated example, in order to maximise use of space, the central portion 8 follows the edge of the upper surface 22 of the cuboid dielectric substrate 20. In other embodiments, when the central portion 8 is curved it may follow the edge of an upper surface of a cylindrical dielectric substrate. The cylinder may be elliptic, circular etc.

The central portion 8 has a central portion width Wᵣ.

The monopole antenna element 40 extends substantially perpendicularly in the second direction D2 from the base of the front surface 26 of the dielectric substrate 20, in the second direction D2, along the front surface 26, to a height h and has a width Wₑ. In some embodiments the height h and width Wₑ may be smaller or larger to provide increasing or decreasing amounts of coupling between the monopole antenna element 40 and the loop antenna 4. It will be apparent to the skilled person that the operational resonant frequency of the monopole antenna element 40 will change accordingly as will the operational resonant frequency of the loop antenna 4. This is described in more detail later. In some embodiments the open end of the monopole antenna element 40 may extend onto the upper surface 22 of the cuboid dielectric substrate 20, but fall short of the central portion 8 so that a gap is maintained between the monopole antenna element 40 and the loop antenna 4.

The radio frequency characteristics of the apparatus 2 will now be explained with reference to FIGS. 3A, 3B, 3C and 3D.

An antenna or other electrical component with a reactive component to its electrical impedance has a dispersive electrical impedance, that is an impedance that varies with frequency. A resonance occurs when the electrical impedance drops to a low value, for example, fifty ohms being the required characteristic impedance for the antenna. In other words, as impedance (Z) is normally represented by a complex number (Z=R±j X), and at resonance the resistive real part (R) of the complex impedance matches the required characteristic impedance, in this example fifty ohms and the reactive imaginary part (X) becomes at or near to zero at least at one discreet frequency. The range of frequencies over which the electrical impedance remains below a threshold value is called the bandwidth of the resonance and the frequency (or frequencies) at which the electrical impedance is minimum is called a resonant frequency.

The radio frequency circuitry 58 and the apparatus 2 may be configured to operate in a plurality of operational resonant frequency bands and via one or more protocols. For example, the operational frequency bands and protocols may include (but are not limited to) Long Term Evolution (LTE) (US) (734 to 746 MHz and 869 to 894 MHz), Long Term Evolution (LTE) (rest of the world) (791 to 821 MHz and 925 to 960 MHz), amplitude modulation (μM) radio (0.535-1.705 MHz); frequency modulation (FM) radio (76-108 MHz); Bluetooth (2400-2483.5 MHz); wireless local area network (WLAN) (2400-2483.5 MHz); hiper local area network (HLAN) (5150-5850 MHz); global positioning system (GPS) (1570.42-1580.42 MHz); US-Global system for mobile communications (US-GSM) 850 (824-894 MHz) and 1900 (1850-1990 MHz); European global system for mobile communications (EGSM) 900 (880-960 MHz) and 1800 (1710-1880 MHz); European wideband code division multiple access (EU-WCDMA) 900 (880-960 MHz); personal communications network (PCN/DCS) 1800 (1710-1880 MHz); US wideband code division multiple access (US-WCDMA) 1700 (transmit: 1710 to 1755 MHz, receive: 2110 to 2155 MHz) and 1900 (1850-1990 MHz); wideband code division multiple access (WCDMA) 2100 (transmit: 1920-1980 MHz, receive: 2110-2180 MHz); personal communications service (PCS) 1900 (1850-1990 MHz); time division synchronous code division multiple access (TD-SCDMA) (1900 MHz to 1920 MHz, 2010 MHz to 2025 MHz), ultra wideband (UWB) Lower (3100-4900 MHz); UWB Upper (6000-10600 MHz); digital video broadcasting-handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz, 3400-3800 MHz, 5250-5875 MHz); digital audio broadcasting (DAB) (174.928-239.2 MHz, 1452.96-1490.62 MHz); radio frequency identification low frequency (RFID LF) (0.125-0.134 MHz); radio frequency identification high frequency (RFID HF) (13.56-13.56 MHz); radio frequency identification ultra high frequency (RFID UHF) (433 MHz, 865-956 MHz, 2450 MHz).

An operational bandwidth is a frequency range over which an antenna can efficiently operate. Efficient operation occurs, for example, when the antenna's insertion loss S11 is greater than an operational threshold T such as 4 dB or 6 dB or the illustrated 10 dB in the Figs.

The loop antenna 4 is configured to have a first resonance R_{L} and the monopole antenna element 40 is configured to have a second resonance R_{M} adjacent the first resonance R_{L}. ‘Adjacent’ in this context means that the bandwidths of the first resonance R_{L} and the second resonance R_{M} overlap to form a combined resonance R for the apparatus 2 that has a continuous operational bandwidth that extends over at least portions of both the first resonance R_{L} and the second resonance R_{M}. In the illustrated examples, the combined resonance R is characterized by an operational bandwidth having less than 10 dB return loss between at 7.2 and 8.5 GHz.

An electrical impedance of the loop antenna 4 is controlled to control characteristics of the combined resonance R such as a first resonant frequency and/or a first operational bandwidth of the first resonance R_{L}. As the loop antenna 4 operates as a parasitic loop antenna, the first resonant frequency R_{L} it generates has an equivalent wavelength λ1 equal to an electrical length of the loop antenna 4.

An electrical impedance of the monopole antenna element 40 is controlled to control characteristics of the combined resonance R such as a second resonant frequency and/or a second operational bandwidth of the second resonance R_{M}. As the monopole antenna element 40 operates as a monopole antenna, the second resonant frequency R_{M} it generates has an equivalent wavelength λ2 equal to four times an electrical length of the monopole antenna element 40.

FIG. 3A illustrates a consequence of varying the width Wₛ in the example illustrated in FIG. 2. Varying the width Wₛ controls characteristics of the first resonance R_{L} and the second resonance R_{M}. Increasing the first width Wₛ increases a resonant frequency of the first resonance R_{L}, increases an operational bandwidth of the first resonance R_{L}, decreases a resonant frequency of the second resonance R_{M} and decreases an operational bandwidth of the second resonance R_{M}.

It may be that increasing Wₛ increases the capacitive coupling between the loop antenna 4 and the monopole antenna element 40 increasing the capacitance associated with the second resonance R_{M}.

It may be that increasing Wₛ decreases the inductance associated with the first resonance R_{L}.

FIG. 3B illustrates a consequence of varying the central portion width Wᵣ. Varying the width Wᵣ controls characteristics of the first resonance. Increasing the central portion width Wᵣ decreases a resonant frequency of the first resonance and increases an operational bandwidth of the first resonance.

It may be that increasing Wᵣ increases the capacitance of the loop antenna 4 increasing the capacitance associated with the first resonance R_{L}.

FIG. 3C illustrates a consequence of varying the height h of the monopole antenna element 40. Varying the height h controls characteristics of the first and/or second resonance. Increasing the height h increases an operational bandwidth of the first resonance R_{L} and decreases a resonant frequency of the second resonance and decreases an operational bandwidth of the second resonance R_{M}.

It may be that increasing the height h increases the inductance of the monopole antenna element 40 increasing the inductance associated with the first resonance R_{L}.

FIG. 3D illustrates that varying the width Wₑ of the monopole antenna element 40 does not significantly impact on characteristics of the first and/or second resonance.

FIG. 4A illustrates a combined resonance R for an apparatus 2 having the following dimensions La=3.2 mm, Lb=Lc=5 mm, Wᵣ=0.6 mm, h=4.4 mm, Wₑ=1.4 mm, Wₛ=0.8 mm. As illustrated this gives an operational bandwidth of 6.7 GHz to 8.91 GHz at 10 dB or better.

FIG. 4B illustrates a plot of the realized gain. The antenna apparatus 2 has a substantially flat antenna efficiency/gain over a range of frequencies (6.8-9 GHz) that is wider than 2 GHz.

Referring back to FIG. 2, the antenna apparatus 2 is typically installed on a printed circuit/wiring board (PCB/PWB) 70 which provides the ground plane 3 and the second conduction path 32.

There is typically a feed connector 72 on the PWB 70. This feed connector 72 may be connected to a 50 Ohm transmission line e.g. the core of a coaxial cable or a suitably designed microstrip feedline which is disposed on at least one layer of the printed wiring board (In real situation, the inner part of the 50 ohm line will be connected directly to the radio chip 58). The feed connector 72 is positioned and arranged to form a connection with a feed part 82 on a base 80 of the dielectric substrate 20. The feed part 82 is connected to the monopole antenna element 40.

There are also typically two ground connectors 74A, 74B on the PWB 70. A first ground connector 74A is positioned and arranged to form a connection with a first ground part 84A on the base 80 of the dielectric substrate 20. The first ground part 84A is connected to the first lateral portion 10A.

A second ground connector 74B is positioned and arranged to form a connection with a second ground part 84B on the base 80 of the dielectric substrate 20. The second ground part 84B is connected to the second lateral portion 10B.

The feed connector 72 and the first and second ground connectors 74A, 74B may be formed from a metallic material such as solder on an upper surface of the PWB 70. The feed part 82 and the first and second ground parts 84A, 84B may be formed from a metallic material such as solder on a lower surface defined by the base 80 of the dielectric substrate 20. During a surface mounted device (SMD) procedure, the feed connector 72 fuses with the feed part 82, the first ground connector 74A fuses with the first ground part 84A and the second ground connector 74B fuses with the second part 84B. This secures the dielectric substrate 20 to the printed wiring board 70. It also creates a feed for the formed antenna apparatus 2 and completes the second conductive path 32 for the antenna apparatus 2.

FIG. 5 schematically illustrates a user apparatus 50 that comprises the apparatus 2 and uses it as an antenna.

The user apparatus 50 comprises a processor 54, a memory 52, radio frequency circuitry 58 for transmission and/or reception of radio signals, a user interface 56 and the apparatus 2.

The processor 54 is configured to read from and write to the memory 52.

The processor 54 is configured to receive commands from the user interface 56 and/or to provide commands to the user interface 56. This may enable a user to control operation of the user apparatus 50 and/or to be informed of the results of operations of the user apparatus 50.

The processor 54 is configured to provide data to the radio frequency circuitry 58 for transmission using the apparatus 2 as an antenna and/or to receive data from the radio frequency circuitry 58 after reception using the apparatus 2 as an antenna.

The impedance matching between the radio frequency circuitry 58 and the apparatus 2 and the tuning of the combined resonance R of the apparatus 2 may be achieved by controlling the layout and dimensions of the loop antenna 4 and the monopole antenna element without the need to use additional distributed and/or lumped reactive components, although at least a transmission line feed will be required between the apparatus 2 and the radio frequency circuitry 58.

The user apparatus 50 may be a mobile apparatus such as a hand-portable apparatus. A hand-portable apparatus is sized to enable the apparatus to be held in a hand and carried in a jacket pocket or hand bag.

The user apparatus 50 may be a mobile phone, mobile computer, laptop, personal digital assistant or other personal electronic device. The user apparatus 50 may also be any non-portable device, for example, server, router, node, or other wireless computing or a device having wireless radio frequency technology, as non-limiting examples.

The user apparatus 50 is an ultra wideband (UWB) enabled apparatus. It can transmit and/or receive data at high data rates over short distances e.g. data rates greater than 100 Mb/s. It may be used for short distance file transfer or similar.

The user apparatus 50 comprises a housing 51 and the apparatus 2 may be located at a central location within the housing 51. The apparatus 2, in this configuration, may produce a uniform radiation pattern with a substantially flat antenna efficiency/gain over a range of frequencies.

The user apparatus 50 may comprise a printed wiring board 53 for supporting its components (memory 52, processor 54, radio frequency circuitry 58 and apparatus 2). The printed wiring board 53 may provide the ground plane 3 for the apparatus 2. The apparatus 2 may be easily mounted on the printed wiring board as a surface mounted device (SMD). The apparatus 2 may alternatively be mounted in a cover of the user apparatus 50, where the cover forms part of the housing 51.

The components may be operationally coupled and any number or combination of intervening elements can exist (including no intervening elements).

Implementation of a processor can be in hardware alone (a circuit, a microprocessor . . . ), have certain aspects in software including firmware alone or can be a combination of hardware and software (including firmware).

As used here ‘module’ refers to a unit or apparatus that excludes certain parts/components that would be added by an end manufacturer or a user. The apparatus 2 may be a module.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus comprising:
a central portion extending at least in a first direction on an upper surface of a dielectric substrate;
a first lateral portion and a second lateral portion extending at least in a second direction, orthogonal to the first direction, on one or more side surfaces of the dielectric substrate to the upper surface of the dielectric substrate;
wherein the central portion provides a first conductive path between the first lateral portion and the second lateral portion;
a second conductive path between the first lateral portion and the second lateral portion; and
a monopole antenna element extending in the second direction,
wherein the combination of the first conductive path and the second conductive path is configured to have a first resonance and wherein the monopole antenna element is configured to have a second resonance adjacent the first resonance, wherein the first resonance and the second resonance form a combined resonance for the apparatus.

2. (canceled)

3. An apparatus as claimed in claim 1, wherein the dielectric substrate has a depth in a third direction orthogonal to the first direction and the second direction, a width in the first direction and a height in the second direction wherein the depth is less than the width and less than the height.

4. (canceled)

5. An apparatus as claimed in claim 1, wherein the dielectric substrate is at least one of ceramic, and plastic, and a combination of ceramic and plastic.

6. (canceled)

7. An apparatus as claimed in claim 1, wherein the combined resonance is characterized by an operational bandwidth having less than 10 dB return loss between at 7.2 and 8.5 GHz.

8. An apparatus as claimed in claim 1, wherein an electrical length of the combination of the first conductive path and the second conductive path is controlled to control characteristics of the combined resonance.

9. An apparatus as claimed in claim 1, wherein an electrical length of the combination of the first conductive path and the second conductive path is controlled to control a first resonant frequency and/or a first operational bandwidth of the first resonance.

10. An apparatus as claimed in claim 1, wherein an electrical length of the monopole antenna element is controlled to control characteristics of the combined resonance.

11. An apparatus as claimed in claim 1, wherein an electrical length of the monopole antenna element is controlled to control a second resonant frequency and/or a second operational bandwidth of the second resonance.

12. An apparatus as claimed in claim 1, wherein the first lateral element and the second lateral element extend in the second direction to a first height and have a first width wherein the first width is controlled to control characteristics of the first resonance and the second resonance.

13. An apparatus as claimed in claim 12, wherein increasing the first width increases a resonant frequency of the first resonance, increases an operational bandwidth of the first resonance, decreases a resonant frequency of the second resonance and decreases an operational bandwidth of the second resonance.

14. An apparatus as claimed in claim 1, wherein the central portion has a central portion width wherein the central portion width is controlled to control characteristics of the first resonance.

15. An apparatus as claimed in claim 14, wherein increasing the central portion width decreases a resonant frequency of the first resonance and increases an operational bandwidth of the first resonance.

16. An apparatus as claimed in claim 1, wherein the monopole antenna element extends in the second direction to a second height and wherein the second height is controlled to control characteristics of the first and/or second resonances.

17. An apparatus as claimed in claim 16, wherein increasing the second height increases an operational bandwidth of the first resonance and decreases a resonant frequency of the second resonance and decreases an operational bandwidth of the second resonance.

18-21. (canceled)

22. An apparatus as claimed in claim 1 configured to operate as an ultra wide-band transmitter and/or receiver without lumped reactive components.

23. A user apparatus comprising the apparatus of claim 1.

24. A method comprising:
providing
a central portion extending at least in a first direction on an upper surface of a dielectric substrate;
a first lateral portion and a second lateral portion extending at least in a second direction, orthogonal to the first direction, on one or more side surfaces of the dielectric substrate to the upper surface of the dielectric substrate;
wherein the central portion provides a first conductive path between the first lateral portion and the second lateral portion; and
a second conductive path between the first lateral portion and the second lateral portion; and
providing a monopole antenna element extending in the second direction,
wherein the combination of the first conductive path and the second conductive path is configured to have a first resonance and wherein the monopole antenna element is configured to have a second resonance adjacent the first resonance, wherein the first resonance and the second resonance form a combined resonance for the apparatus.

25-35. (canceled)

36. An apparatus as claimed in claim 1, wherein the central portion provides a third conductive path, different from the first conductive path and the second conductive path, between the first lateral portion and the second lateral portion.

37. An apparatus as claimed in claim 36, wherein the first conductive path and the third conductive path provided by the central portion form a closed loop.

38. A method as claimed in claim 24, wherein the central portion provides a third conductive path, different from the first conductive path and the second conductive path, between the first lateral portion and the second lateral portion.
